(19) United States
(12) Patent Application Publication
(10) Pub. No.: US 2015/0148466 A1
(43) Pub. Date: May 28, 2015

(54) POLYESTER COMPOSITIONS

(71) Applicant: LANXESS Deutschland GmbH, Cologne (DE)

(72) Inventors: Timo IMMEL, Dormagen (DE); Jochen ENDTNER, Cologne (DE); Matthias BIENMUELLER, Krefeld (DE)

(21) Appl. No.: 14/548,838

(22) Filed: Nov. 20, 2014

(30) Foreign Application Priority Data
Nov. 27, 2013 (EP) 13194637.8
Jan. 18, 2014 (DE) 102014000612.3

(51) Int. Cl. C08L 67/02; B29C 47/00; C08J 5/04; B29C 45/00

(52) U.S. Cl. CPC C08L 67/02; B29C 45/0001; B29C 47/0004; C08J 5/043; B29K 2067/003
USPC 524/126; 524/539; 524/497; 524/494; 524/451; 264/328.1

(57) ABSTRACT

The invention relates to compositions comprising polyethylene terephthalate (PET), poly(1,4-cyclohexanedimethanol terephthalate) (PCT) and titanium dioxide, to the use of these compositions for production of products resistant to heat distortion for short periods, and to a process for producing polyester-based products resistant to heat distortion for short periods, preferably electric or electronic polyester-based products, especially polyester-based optoelectronic products.

The invention relates to compositions, especially thermoplastic moulding compositions, comprising polyethylene terephthalate (PET), poly(1,4-cyclohexanedimethanol terephthalate) (PCT) and titanium dioxide, to the use of these compositions in the form of moulding compositions for production of products resistant to heat distortion for short periods, and to a process for producing polyester-based products resistant to heat distortion for short periods, preferably electric or electronic polyester-based products, especially polyester-based optoelectronic products.

### PRIOR ART

EP 2465896 A1 describes compositions based on PET and polybutylene terephthalate (PBT), and also titanium dioxide and glass fibres, for use in polyester-based products, especially optoelectronic products. U.S. Pat. No. 4,874,809 discloses glass fibre- and mica-reinforced polyesters for low-warpage products based on PET and PCT.

Many electronic and electric assemblies and components include thermally sensitive electric and/or electronic products, for example heat-sensitive integrated circuits, lithium batteries, oscillator crystals, optoelectronic products. In the course of installation of such an assembly, the electrical contacts provided on the products have to be connected in a reliable processing method to conductor tracks on a circuit board and/or to electrical contacts on other products. This installation is frequently effected with the aid of a soldering method, in which solder connections provided on the product are soldered to the circuit board. For each product, there is a safe range for the solder time and solder temperature, in which good solder connections can be produced.

This gives rise to high demands on the materials to be used with regard to short-term heat distortion resistance. In addition, materials of this kind must have high reflection and very good ageing resistance at the temperatures that occur in later use, for example in light-emitting diodes (LEDs).

WO 2010/049531 A1 discloses what are called power LEDs based on aromatic polyesters or fully aromatic polyesters, which are said to prevent the degradation of the thermoplastic material by heat or radiation. The use of these aromatic polyesters or fully aromatic polyesters, especially based on p-hydroxybenzoic acid, terephthalic acid, hydroquinone or 4,4′-bisphenol, and optionally isophthalic acid, leads to a longer-lasting lighting performance of these power LEDs. One disadvantage of the aromatic polyesters of WO 2010/049531 A1, however, is the high processing temperature in the melt, which is at temperatures of 355° C. or higher because of the high melting points of the polymers described, and another the high mould temperatures of 175° C. or higher. High processing and mould temperatures require special and expensively modified injection moulding machines, especially in the heating and cooling of the moulds. Moreover, high processing temperatures lead to increased wear on the injection moulding unit in the injection moulding machines intended for the processing of such moulding compositions containing aromatic polyesters.

JP-A-55027335 and WO2012/080361A1 disclose compositions comprising PET as polyester, titanium dioxide and glass fibres for the purpose of use in the field of optoelectronic products. PET-based compositions of this kind and products produced therefrom are only of limited usability at the high wave soldering temperatures because of the low melting point of PET and the resulting limited short-term heat distortion resistance.

In order to achieve a good solder result, products which are used for production of light-emitting diodes (LEDs) have to be exposed to elevated temperatures during the soldering over prolonged periods. For example, in the course of wave soldering, the product inserted into the circuit board is first heated gradually to about 100° C. This is followed by the actual soldering, which is typically effected in the range from about 260° C. to 285° C. and takes at least 5 seconds when lead-free solders are used, followed by the solidification phase during which the product cools down gradually. According to http://de.wikipedia.org/wiki/Wellenl%C3% B6ten (wave soldering), wave soldering, also referred to as flow soldering, is a soldering method by which electronic assemblies (circuit boards, flat assemblies) can be soldered in a semiautomatic or fully automatic manner after fitting. The solder side of the circuit board is first wetted with a flux in the fluxer. Thereafter, the circuit board is preheated by means of convection heating (swirling of the heat, as a result of which the same temperature is present virtually everywhere, even on the upper side), coil heating or infrared radiators. This is done firstly in order to vaporize the solvent content of the flux (otherwise bubbles will be formed in the soldering operation), to increase the chemical efficacy of the activators used, and to avoid thermal warpage of the assembly and damage to the components as a result of an excessively steep temperature rise in the course of subsequent soldering. In general, a temperature differential of less than 120° C. is required. This means that the circuit board has to be heated to at least 130° C. in the case of a soldering temperature of 250° C.

Exact data are found through temperature profiles. This involves mounting temperature sensors at relevant points on a specimen circuit board and recording with a measuring instrument. This gives temperature curves for the upper and lower sides of the circuit board for selected components. Thereafter, the assembly is run over one or two solder waves. The solder wave is generated by pumping liquid solder through an orifice. The solder temperature is about 250° C. in the case of lead-containing solders, and about 10° C. to 35° C. higher in the case of lead-free solders which are to be used with preference due to the avoidance of lead-containing vapours, i.e. 260° C. to 285° C.

The solder time should be selected such that the heating damages neither the circuit board nor the heat-sensitive components. The solder time is the contact time with the liquid solder per solder site. The guideline times for circuit boards laminated on one side are less than one second, and for circuit boards laminated on both sides not more than two seconds. In the case of multiple circuit boards, individual solder times of up to six seconds apply. According to DIN EN 61760-1 from 1998, the maximum period for one wave or else two waves together is 10 seconds. More specific details can be taken from the abovementioned reference. After the soldering, cooling of the assembly is advisable, in order to rapidly reduce the thermal stress again. This is accomplished via direct cooling by means of a cooling unit (climate control system) immediately downstream of the soldering region and/or by means of conventional ventilators in the sink station or a cooling tunnel on the return belt.

WO 2007/033129 A2 describes thermally stable compositions for LED housings based on PCT, and also titanium oxide and glass fibres, which may optionally also comprise other thermoplastic polyesters, including PET, in an amount of up to 70% by weight, based on the total weight of the PCT. Disadvantages of the compositions according to WO 2007/033129 A2 are the poorer mechanical properties compared to pure PET, and the more difficult processibility thereof, resulting from the slower crystallization of the PCT.

The problem addressed by present invention was therefore that of combining compositions based on PCT with the favourable properties of PET, such that they ultimately have optimized properties in relation to short-term heat distortion resistance, reflection after thermal stress, better mechanical properties and simultaneously low processing temperatures in the melt.

### INVENTION

The solution to the problem and the subject-matter of the present invention are compositions, especially thermoplastic moulding compositions, comprising
a) 3% to 30% by weight, preferably 5% to 25% by weight, more preferably 10% to 20% by weight, of poly(1,4-cyclohexylenedimethylene) terephthalate (PCT), where the proportion of PCT based on the sum total of all the thermoplastic polymers present in the composition is in the range from 5% to 40% by weight, preferably 7% to 30% by weight, more preferably 10-25% by weight,
b) 15% to 90% by weight, preferably 20% to 70% by weight, more preferably 30% to 60% by weight, of polyethylene terephthalate (PET) and
c) 7% to 70% by weight, preferably 10% to 40% by weight, more preferably 15% to 35% by weight, of titanium dioxide, where the individual components should be combined with one another in such a way that the sum total of all the percentages by weight is 100.

For clarity, it should be noted that the scope of the present invention encompasses all the definitions and parameters mentioned hereinafter in general terms or specified within areas of preference, in any desired combinations. In addition, for clarity, it should be noted that the compositions, in a preferred embodiment, may be mixtures of components a), b) and c), and also thermoplastic moulding compositions that can be produced from these mixtures by means of processing operations, preferably by means of at least one mixing or kneading apparatus, but also products that can be produced from these in turn, especially by extrusion or injection moulding. Unless stated otherwise, all figures are based on room temperature (RT)=23+/−2° C. and on standard pressure=1 bar.

The preparation of the compositions according to the present invention for their further processing takes place by mixing components a), b) and c) to be used as educts in at least one mixing tool. Mouldings are obtained as intermediate products and based on the compositions according to the present invention. These mouldings can exist either exclusively of the components a), b) and c), or include, however, in addition, to the components a), b) and c) even other components. In this case the components a), b) and c) are to be varied within the scope of the given amount areas in such a way that the sum of all weight percent always results in 100.

In the case of thermoplastic moulding compositions and products that can be produced therefrom, the proportion of the inventive compositions therein is preferably in the range from 50 to 100% by weight, the other constituents being additives selected by those skilled in the art in accordance with the later use of the products, preferably from at least one of components d) to h) defined hereinafter.

Good mechanical properties in the context of the present invention, in the case of the products obtainable from the inventive compositions, feature high values for the Izod impact resistance, while maintaining high values for the flexural modulus. Impact resistance describes the ability of a material to absorb impact energy and shock energy without fracturing. The testing of Izod impact resistance to ISO 180 is a standard method for determining impact resistance of materials. This involves first holding an arm at a particular height (=constant potential energy) and finally releasing it. The arm hits the sample, fracturing it. The impact energy is determined from the energy which is absorbed by the sample. Impact resistance is calculated as the ratio of impact energy and sample cross section (unit of measurement: kJ/m²). Impact resistance was determined in the context of the present invention in analogy to ISO 180-1U at 23° C. According to “http://de.wikipedia.org/wiki/Begeversuch”, the flexural modulus is determined in a 3-point bending test, by positioning a test specimen on two rests and loading it with a test ram in the middle. This is probably the most commonly used form of flexural test. The flexural modulus is then calculated in the case of a flat sample as follows:

$$E = \frac{{l}_{v}^{3} ( {X}_{H} - {X}_{L} )}{4 {D}_{L} {ba}^{3}}$$

where E=flexural modulus in kN/mm²; Iᵥ=support width in mm; X_{H}=end of flexural modulus determination in kN; X_{L}=start of flexural modulus determination in kN; D_{L}=deflection in mm between X_{H} and X_{L}; b=sample width in mm; a=sample thickness in mm. Flexural modulus was determined in the context of the present invention in analogy to ISO 178-A at 23° C.

### PREFERRED EMBODIMENTS OF THE INVENTION

In a preferred embodiment, the present invention relates to compositions, especially thermoplastic moulding compositions, comprising, in addition to components a), b) and c), also
d) 5% to 50% by weight, preferably 10% to 40% by weight, more preferably 13% to 33% by weight, of glass fibers, in which case the level of at least one of components a), b) and c) should be reduced to such an extent that the sum total of all the percentages by weight is 100.

In a preferred embodiment, the Inventive compositions, especially thermoplastic moulding compositions, comprise, in addition to components a) to d) or instead of d), also
e) 0.01% to 15% by weight, preferably 0.01% to 10% by weight, more preferably 0.01% to 5% by weight, of talc, preferably microcrystalline talc, in which case the level of at least one of the other components should be reduced to such an extent that the sum total of all the percentages by weight is 100.

In a preferred embodiment, the inventive compositions, especially thermoplastic moulding compositions, comprise, in addition to a), b) and c) and optionally d) and/or e), or instead of components d) and/or e), also
f) 0.01% to 1% by weight, preferably 0.1% to 1% by weight, more preferably 0.5% to 1% by weight, of at least one phosphite stabilizer, in which case the level of at least one of the other components should be reduced to such an extent that the sum total of all the percentages by weight is 100.

In a preferred embodiment, the inventive compositions, especially thermoplastic moulding compositions, comprise, in addition to components a), b) and c) and optionally d) and/or e) and/or f), or instead of components d), e) and/or f), also
g) 0.01% to 15% by weight, preferably 0.01% to 10% by weight, more preferably 0.01% to 5% by weight, of at least one demoulding agent, in which case the level of at least one of the other components should be reduced to such an extent that the sum total of all the percentages by weight is 100.
In a preferred embodiment, the inventive compositions, especially thermoplastic moulding compositions, comprise, in addition to components a), b) and c) and optionally d) and/or e) and/or f) and/or g), or instead of components d), e), f) and/or g), also
h) 0.01% to 15% by weight, preferably 0.01% to 10% by weight, more preferably 0.01% to 5% by weight, of at least one additive other than components c) to g), in which case the level of at least one of the other components should be reduced to such an extent that the sum total of all the percentages by weight is 100.

### Component a)

According to the invention, a blend of component a) PCT and component b) PET is used. PCT (CAS No. 24936-69-4) can be purchased, for example, from SK Chemicals under the Puratan® trade name. PCT for use with preference has an intrinsic viscosity in the range from about 30 cm³/g to 150 cm³/g, more preferably in the range from 40 cm³/g to 130 cm³/g, most preferably in the range from 60 cm³/g to 120 cm³/g, in each case measured in phenol/o-dichlorobenzene (1:1 parts by weight) at 25° C. by means of an Ubbelohde viscometer. Intrinsic viscosity [η] is also called limiting viscosity number or Staudinger index, since it is firstly a material constant and secondly is related to the molecular weight. It indicates how the viscosity of the solvent is affected by the dissolved substance. Intrinsic viscosity is determined using the following definition:

$$[ η ] = {lim}_{c \to 0 } \frac{{η}_{sp}}{c} = {lim}_{c \to 0} \frac{1}{c} ln ( \frac{η}{{η}_{0}} )$$

where c is the concentration of the dissolved substance in g/ml, η₀ is the viscosity of the pure solvent and

$${η}_{sp} = \frac{η}{{η}_{0}} - 1$$

is the specific viscosity.

The viscosity is measured by drying the material to a moisture content of not more than 0.02%, determined by means of the Karl Fischer method known to those skilled in the art, in a commercial air circulation dryer at 120° C. (see: http://de.wikipedia.org/wiki/Kari-Fischer-Verfahren).

### Component b)

The PET (CAS No. 25038-59-9) for use as component b) is a reaction product of aromatic dicarboxylic acids or the reactive derivatives thereof, preferably dimethyl esters or anhydrides, and aliphatic, cycloaliphatic or araliphatic diols and mixtures of these reactants. PET can be prepared from terephthalic acid (or the reactive derivatives thereof) and the particular aliphatic diols having 2 or 4 carbon atoms by known methods (Kunststoff-Handbuch (Plastics Handbook), vol. VIII, p. 695-703, Karl-Hanser-Verlag, Munich 1973).

PET for use with preference as component b) contains at least 80 mol %, preferably at least 90 mol %, based on the dicarboxylic acid, of terephthalic acid residues and at least 80 mol %, preferably at least 90 mol %, based on the diol component, of ethylene glycol residues.

PET for use with preference as component b) may contain, as well as terephthalic acid residues, up to 20 mol % of residues of other aromatic dicarboxylic acids having 8 to 14 carbon atoms or residues of aliphatic dicarboxylic acids having 4 to 12 carbon atoms, preferably residues of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid or cyclohexanedicarboxylic acid.

PET for use with preference as component b) may, as well as ethylene glycol or butane-1,4-diol glycol residues, contain up to 20 mol % of other aliphatic diols having 3 to 12 carbon atoms or cycloaliphatic diols having 6 to 21 carbon atoms. Preference is given to residues of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,6-diol, 2-ethylhexane-1,3-diol, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane or 2,2-bis(4-hydroxypropoxyphenyl)propane (DE-A 24 07 674 (=U.S. Pat. No. 4,035,958), DE-A 24 07 776, DE-A 27 15 932 (=U.S. Pat. No. 4,176,224)).

In one embodiment, the PET for use as component b) in accordance with the invention may be branched through incorporation of relatively small amounts of tri- or tetrahydric alcohols or tri- or tetrabasic carboxylic acids, as described, for example, in DE-A 19 00 270 (=U.S. Pat. No. 3,692,744). Preferred branching agents are trimesic acid, trimellitic acid, trimethylolethane and trimethylolpropane, and pentaerythritol.

The PET for use in accordance with the invention preferably has an intrinsic viscosity in the range from about 30 cm³/g to 150 cm³/g, more preferably in the range from 40 cm³/g to 130 cm³/g, especially preferably in the range from 50 cm³/g to 100 cm³/g, in each case measured in analogy to ISO 1628-1 in phenol/o-dichlorobenzene (1:1 parts by weight) at 25° C. by means of an Ubbelohde viscometer.

The viscosity is measured by drying the material to a moisture content of not more than 0.02%, determined by means of the Karl Fischer method known to those skilled in the art, in a commercial air circulation dryer at 120° C.

The polyesters of component a) PCT and of component b) PET may optionally also be used in a mixture with other polyesters and/or further polymers.

### Component c)

The titanium dioxide for use as component c) (CAS No. 13463-67-7) preferably has a median particle size (d50) in the range from 90 nm to 2000 nm, more preferably in the range from 200 to 800 nm, determined by means of the Debye-Scherrer method known to those skilled in the art (see: http://de.wikipedia.org/wiki/Debye-Scherrer-Verfahren).

Useful titanium dioxide pigments for the titanium dioxide for use in accordance with the invention as component c) include those whose base structures can be produced by the sulphate (SP) or chloride (CP) method, and which preferably have anatase (CAS No. 1317-70-0) and/or rutile structure (CAS No. 1317-80-2), more preferably rutile structure. The base structure need not be stabilized, but preference is given to a specific stabilization: in the case of the CP base structure by an Al doping of 0.3-3.0% by weight (calculated as Al₂O₃) and an oxygen excess in the gas phase in the oxidation of the titanium tetrachloride to titanium dioxide of at least 2%; in the case of the SP base structure by a doping, preferably with Al, Sb, Nb or Zn. In order to obtain a sufficiently high brightness of the products to be produced from the compositions, particular preference is given to “light” stabilization with Al, or compensation with antimony in the case of higher amounts of Al dopant. In the case of use of titanium dioxide as white pigment in paints and coatings, plastics etc., it is known that unwanted photocatalytic reactions caused by UV absorption lead to breakdown of the pigmented material. This involves absorption of light in the near ultraviolet range by titanium dioxide pigments, forming electron-hole pairs, which produce highly reactive free radicals on the titanium dioxide surface. The free radicals formed result in binder degradation in organic media. Preference is given in accordance with the invention to lowering the photoactivity of the titanium dioxide by inorganic aftertreatment thereof, more preferably with oxides of Si and/or Al and/or Zr and/or through the use of Sn compounds.

Preferably, the surface of pigmentary titanium dioxide is covered with amorphous precipitated oxide hydrates of the compounds SiO₂ and/or Al₂O₃ and/or zirconium oxide. The Al₂O₃ shell facilitates pigment dispersion in the polymer matrix; the SiO₂ shell makes it difficult for charges to be exchanged at the pigment surface and hence reduces polymer degradation.

According to the invention, the titanium dioxide is preferably provided with hydrophilic and/or hydrophobic organic coatings, especially with siloxanes or polyalcohols.

Commercially available products are, for example, Kronos® 2230, Kronos® 2225 and Kronos® vlp7000 from Kronos, Dallas, USA.

### Component d)

According to “http://de.wikipedia.org/wiki/Faser-Kunststoff-Verbund”, cut fibres, also referred to as short fibres, having a length in the range from 0.1 to 1 mm, are distinguished from long fibres having a length in the range from 1 to 50 mm and continuous fibres having a length L>50 mm. Short fibres are used in injection moulding technology and can be processed directly in an extruder. Long fibres can likewise still be processed in extruders. They are used on a large scale in fibre injection moulding. Long fibres are frequently added to thermosets as a filler. Continuous fibres are used in the form of rovings or fabric in fibre-reinforced plastics. Products comprising continuous fibres achieve the highest stiffness and strength values. Additionally supplied are ground glass fibres having a length after grinding typically in the range from 70 to 200 μm.

According to the invention, chopped long glass fibres having a starting length in the range from 1 to 50 mm, more preferably in the range from 1 to 10 mm, most preferably in the range from 2 to 7 mm, are used for component d). The glass fibres of component d) may, as a result of the processing to give the moulding composition or to give the product, have a lower d97 or d50 value in the moulding composition or in the product than the glass fibres originally used. Thus, the arithmetic mean of the glass fibre length after processing is frequently only in the range from 150 μm to 300 μm.

The glass fibre length and glass fibre length distribution are determined in the context of the present invention, in the case of processed glass fibres, in analogy to ISO 22314, which first stipulates ashing of the samples at 625° C. Subsequently, the ash is placed onto a microscope slide covered with demineralized water in a suitable crystallizing dish, and the ash is distributed in an ultrasound bath with no action of mechanical forces. The next step involves drying in an oven at 130° C., followed by the determination of the glass fibre length with the aid of light microscopy images. For this purpose, at least 100 glass fibres are measured in three images, and so a total of 300 glass fibres are used to ascertain the length. The glass fibre length either can be calculated as the arithmetic mean Iₙ according to the equation

$$\text{?} = \frac{1}{n} \cdot \text{?}$$

$$\text{?} \text{indicates text missing or illegible when filed}$$

where Iₗ=length of the ith fibre and n=number of fibres measured, and be shown in a suitable manner as a histogram, or, in the case that a normal distribution of the glass fibre lengths I measured is assumed, can be determined with the aid of the Gaussian function according to the equation

$$f ( l ) = \frac{1}{\sqrt{2 π} \cdot σ} \cdot \text{?}$$

$$\text{?} \text{indicates text missing or illegible when filed}$$

Here, I_{c} and σ are specific characteristic values of the normal distribution; I_{c} is the median value and σ the standard deviation (see: M. Schoβig, Schädigungsmechanismen in faserverstärkten Kunststoffen [Damage Mechanisms in Fibre-Reinforced Plastics], 1, 2011, Vieweg und Teubner Verlag, page 35, ISBN 978-3-8348-1483-8). Glass fibres not incorporated into a polymer matrix are analysed with respect to their lengths by the above methods, but without processing by ashing and separation from the ash.

The glass fibres for use in accordance with the invention as component c) (CAS No. 65997-17-3) preferably have a fibre diameter in the range from 7 to 18 μm, more preferably in the range from 9 to 15 μm, which can be determined by at least one method available to those skilled in the art, and can especially be determined by μ-x-ray computer tomography in analogy to “Quantitative Messung von Faserlängen und -verteilung in faserverstärkten Kunststoffteilen mittels μ-Röntgen-Computertomographie” [Quantitative Measurement of Fibre Length and Distribution in Fibre-Reinforced Plastics Parts by Means of μ-X-Ray Computer Tomography], J. KASTNER, et al. DGZfP Annual Meeting 2007—Presentation 47. The glass fibres for use as component d) are preferably added in the form of continuous fibres or in the form of chopped or ground glass fibres.

The fibres are preferably modified with a suitable slip system and an adhesion promoter or adhesion promoter system, more preferably based on silane.

Very particularly preferred silane-based adhesion promoters, especially for the pretreatment of the glass fibres, are silane compounds of the general formula (I)

(X—(CH₂)_{q})ₖ—Si—(O—CrH₂ᵣ+1)₄₋ₖ (1)

in which the substituents are defined as follows:

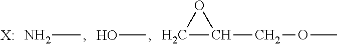

q: an integer from 2 to 10, preferably 3 to 4,
r: an integer from 1 to 5, preferably 1 to 2,
k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane, and the corresponding silanes containing a glycidyl group as the X substituent.

For the modification of the glass fibres, the silane compounds are preferably used in amounts in the range from 0.05% to 2% by weight, more preferably in the range from 0.25% to 1.5% by weight and especially in the range from 0.5% to 1% by weight, based on the glass fibres for surface coating.

The glass fibres may, as a result of the processing to give the moulding composition or the product to be produced therefrom, have a lower d97 or d50 value in the moulding composition or in the product than the glass fibres originally used. The glass fibres may, as a result of the processing to give the moulding composition or shaped bodies, have shorter length distributions in the moulding composition or in the shaped body than originally used.

### Component e)

According to the invention, talc is used as component e), preferably microcrystalline talc. Talc (CAS No. 14807-96-6) is a sheet silicate having the chemical composition Mg₃[Si₄O₁₀(OH)₂], which, according to the polymorph, crystallizes as talc-1A in the triclinic crystal system or as talc-2M in the monoclinic crystal system (http://de.wikipedia.org/wiki/Talkum).

Microcrystalline talc in the context of the present invention is described in WO 2014/001158 A1, the contents of which are fully encompassed by the present disclosure. In one embodiment of the present invention, microcrystalline talc having a median particle size d50 determined using a SediGraph in the range from 0.5 to 10 μm is used, preferably in the range from 1.0 to 7.5 μm, more preferably in the range from 1.5 to 5.0 μm and most preferably in the range from 1.8 to 4.5 μm.

As described in WO 2014/001158 A1, in the context of the present invention, the particle size of the talc for use in accordance with the invention is determined by sedimentation in a fully dispersed state in an aqueous medium with the aid of a “Sedigraph 5100” as supplied by Micrometrics Instruments Corporation, Norcross, Ga., USA. The Sedigraph 5100 delivers measurements and a plot of cumulative percentage by weight of particles having a size referred to in the art as “equivalent sphere diameter” (esd), minus the given esd values. The median particle size d50 is the value determined from the particle esd at which 50% by weight of the particles have an equivalent sphere diameter smaller than this d50 value. The underlying standard is ISO 13317-3.

In one embodiment, microcrystalline talc is defined via the BET surface area. Microcrystalline talc for use in accordance with the invention preferably has a BET surface area, which can be determined in analogy to DIN ISO 9277, in the range from 5 to 25 m²·g⁻¹, more preferably in the range from 10 to 18 m²·g⁻¹, most preferably in the range from 12 to 15 m²·g⁻¹. Talc for use in accordance with the invention can be purchased, for example, as Mistron® R10 from Imerys Talc Group, Toulouse, France (Rio Tinto Group).

### Component f)

According to the invention, at least one phosphite stabilizer is used as component f). Preference is given to using at least one phosphite stabilizer from the group of tris(2,4-di-tert-butylphenyl)phosphite (Irgafos® 168, BASF SE, CAS No. 31570-04-4), bis(2,4-di-tert-butylphenyl)pentaerythrityl diphosphite (Ultranox® 626, Chemtura, CAS No. 26741-53-7), bis(2,6-di-tert-butyl-4-methylphenyl)pentaerythrityl diphosphite (ADK Stab PEP-36, Adeka, CAS No. 80693-00-1), bis(2,4-dicumylphenyl)pentaerythrityl diphosphite (Doverphos® S-9228, Dover Chemical Corporation, CAS No. 154862-43-8), tris(nonylphenyl)phosphite (Irgafos® TNPP, BASF SE, CAS No. 26523-78-4), (2,4,6-tri-t-butylphenol)-2-butyl-2-ethyl-1,3-propanediol phosphite (Ultranox® 641, Chemtura, CAS No. 161717-32-4) and Hostanox® P-EPO.

The phosphite stabilizer used is especially preferably at least Hostanox® P-EPO (CAS No. 119345-01-6) from Clariant International Ltd., Muttenz, Switzerland. This comprises tetrakis(2,4-di-tert-butylphenyl)-1,1-biphenyl-4,4′-diyl bisphosphonite (CAS No. 38613-77-3), which can especially be used with very particular preference as component f) in accordance with the invention.

### Component g)

According to the invention, at least one demoulding agent is used as component g). Preferred demoulding agents used are at least one selected from the group of ester wax(es), pentaerythrityl tetrastearate (PETS), long-chain fatty acids, salt(s) of the long-chain fatty acids, amide derivative(s) of the long-chain fatty acids, montan waxes (CAS No. 8002-53-7) and low molecular weight polyethylene or polypropylene wax(es), and ethylene homopolymer wax(es).

Preferred long-chain fatty acids are stearic acid or behenic acid. Preferred salts of long-chain fatty acids are calcium stearate or zinc stearate. A preferred amide derivative of long-chain fatty acids is ethylenebisstearylamide (CAS No. 110-30-5). Preferred montan waxes are mixtures of straight-chain, saturated carboxylic acids having chain lengths of 28 to 32 carbon atoms.

Especially preferably, the demoulding agent used is an ethylene homopolymer wax which is sold as Luwax® A by BASF SE, Ludwigshafen, Germany (m.p. 101-109° C., according to BASF product brochure EMV e 0108 05.2008).

### Component h)

According to the invention, at least one additive different from components c), d), e), f) and g) can be used as component h).

Additives for component h) are preferably stabilizers, especially UV stabilizers, thermal stabilizers, gamma ray stabilizers, antistats, flow aids, flame retardants, elastomer modifiers, fire prevention additives, emulsifiers, nucleating agents, plasticizers, lubricants, dyes or pigments. These and further suitable additives are described, for example, in Gchter, Miler, Kunststoff-Additive [Plastics Additives], 3rd edition, Hanser-Verlag, Munich, Vienna, 1989 and in the Plastics Additives Handbook, 5th Edition, Hanser-Verlag, Munich, 2001. The additives can be used alone or in a mixture, or in the form of masterbatches.

Stabilizers used are preferably sterically hindered phenols, hydroquinones, aromatic secondary amines such as diphenylamines, substituted resorcinols, salicylates, benzotriazoles and benzophenones, and also variously substituted representatives of these groups or mixtures thereof.

Further dyes or pigments are used as dyes or pigments, irrespective of the titanium dioxide in component c), in order to give a hue to the light emitted in the case of an optoelectronic product, or to improve the light emitted by means of an optical brightener.

Nucleating agents used are preferably sodium phenylphosphinate or calcium phenylphosphinate, alumina (CAS No. 1344-28-1) or silicon dioxide.

Plasticizers used are preferably dioctyl phthalate, dibenzyl phthalate, butyl benzyl phthalate, hydrocarbon oils or or N-(n-butyl)benzenesulphonamide.

The additives used as elastomer modifier is preferably one or more graft polymer(s) E of
E.1 5 to 95% by weight, preferably 30 to 90% by weight, of at least one vinyl monomer
E.2 95 to 5% by weight, preferably 70 to 10% by weight, of one or more graft bases having glass transition temperatures of <10° C., preferably <0° C., more preferably <−20° C.

The graft base E.2 generally has a median particle size (d₅₀) of 0.05 to 10 μm, preferably 0.1 to 5 μm, more preferably 0.2 to 1 μm.

Monomers E.1 are preferably mixtures of
E.1.1 50 to 99% by weight of vinylaromatics and/or ring-substituted vinylaromatics (for example styrene, α-methylstyrene, p-methylstyrene, p-chlorostyrene) and/or (C₁-C₈)-alkyl methacrylates (for example methyl methacrylate, ethyl methacrylate) and
E.1.2 1 to 50% by weight of vinyl cyanides (unsaturated nitriles such as acrylonitrile and methacrylonitrile) and/or (C₁-C₈)-alkyl (meth)acrylates (for example methyl methacrylate, n-butyl acrylate, t-butyl acrylate) and/or derivatives (such as anhydrides and imides) of unsaturated carboxylic acids (for example maleic anhydride and N-phenylmaleimide).

Preferred monomers E.1.1 are selected from at least one of the monomers styrene, α-methylstyrene and methyl methacrylate; preferred monomers E.1.2 are selected from at least one of the monomers acrylonitrile, maleic anhydride and methyl methacrylate.

Particularly preferred monomers are E.1.1 styrene and E.1.2 acrylonitrile.

Graft bases E.2 suitable for the graft polymers for use in the elastomer modifiers are, for example, diene rubbers, EP(D)M rubbers, i.e. those based on ethylene/propylene, and optionally diene, acrylate, polyurethane, silicone, chloroprene and ethylene/vinyl acetate rubbers.

Preferred graft bases E.2 are diene rubbers (for example based on butadiene, isoprene etc.) or mixtures of diene rubbers or copolymers of diene rubbers or mixtures thereof with further copolymerizable monomers (for example as per E.1.1 and E.1.2), with the proviso that the glass transition temperature of component E.2 is below <10° C., preferably <0° C., more preferably <−10° C.

A particularly preferred graft base E.2 is pure polybutadiene rubber.

Particularly preferred polymers E are ABS polymers (emulsion, bulk and suspension ABS), as described, for example, in DE-A 2 035 390 (=U.S. Pat. No. 3,644,574) or in DE-A 2 248 242 (=GB-A 1 409 275) or in Ullmann, Enzyklopädie der Technischen Chemie [Encyclopedia of Industrial Chemistry], vol. 19 (1980), p. 280 ff. The gel content of the graft base E.2 is at least 30% by weight, preferably at least 40% by weight (measured in toluene). ABS means acrylonitrile-butadiene-styrene copolymer with CAS No. 9003-56-9 and is a synthetic terpolymer formed from the three different monomer types acrylonitrile, 1,3-butadiene and styrene. It is one of the amorphous thermoplastics. The ratios may vary from 15-35% acrylonitrile, 5-30% butadiene and 40-60% styrene.

The elastomer modifiers or graft copolymers E are prepared by free-radical polymerization, for example by emulsion, suspension, solution or bulk polymerization, preferably by emulsion or bulk polymerization.

Particularly suitable graft rubbers are also ABS polymers, which are prepared by redox initiation with an initiator system composed of organic hydroperoxide and ascorbic acid to U.S. Pat. No. 4,937,285.

Since, as is well known, the graft monomers are not necessarily grafted completely onto the graft base in the grafting reaction, according to the invention, graft polymers E are also understood to mean those products which are obtained through (co)polymerization of the graft monomers in the presence of the graft base and occur in the workup as well.

Suitable acrylate rubbers are based on graft bases E.2, which are preferably polymers of alkyl acrylates, optionally with up to 40% by weight, based on E.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, especially preferably chloroethyl acrylate, and mixtures of these monomers.

For crosslinking, it is possible to copolymerize monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, for example ethylene glycol dimethacrylate, allyl methacrylate; polyunsaturated heterocyclic compounds, for example trivinyl cyanurate and triallyl cyanurate; polyfunctional vinyl compounds, such as di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5%, especially 0.05% to 2%, by weight, based on the graft base E.2.

In the case of cyclic crosslinking monomers having at least 3 ethylenically unsaturated groups, it is advantageous to restrict the amount to below 1% by weight of the graft base E.2.

Preferred “other” polymerizable, ethylenically unsaturated monomers which, alongside the acrylic esters, may optionally serve for preparation of the graft base E.2 are, for example, acrylonitrile, styrene, α-methylstyrene, acrylamide, vinyl C₁-C₆-alkyl ethers, methyl methacrylate, butadiene. Preferred acrylate rubbers as graft base E.2 are emulsion polymers having a gel content of at least 60% by weight.

Further suitable graft bases according to E.2 are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Additives for use as flame retardants are commercial organic halogen compounds with or without synergists or commercial halogen-free flame retardants based on organic or inorganic phosphorus compounds other than component f), or organic nitrogen compounds, individually or in a mixture.

Halogenated, especially brominated and chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers. Suitable phosphorus compounds include the phosphorus compounds according to WO-A 98/17720 (=U.S. Pat. No. 6,538,024), preferably metal phosphinates, especially aluminium phosphinate and zinc phosphinate, metal phosphonates, especially aluminium phosphonate, calcium phosphonate and zinc phosphonate and the corresponding hydrates of the metal phosphonates, and also derivatives of the 9,10-dihydro-9-oxa-10-phosphaphenanthrene 10-oxides (DOPO derivatives), triphenyl phosphate (TPP), resorcinol bis(diphenyl phosphate) (RDP), including oligomers, and bisphenol A bis(diphenyl phosphate) (BDP) including oligomers, polyphosphonates (for example Nofiao HM1100 from FRX Polymers, Chelmsford, USA), and also zinc bis(diethylphosphinate), aluminium tris(diethylphosphinate), melamine phosphate, melamine pyrophosphate, melamine polyphosphate, melamine poly(aluminium phosphate), melamine poly(zinc phosphate) and phenoxyphosphazene oligomers and mixtures thereof. Useful nitrogen compounds include especially melamine and melamine cyanurate and reaction products of trichlorotriazine, piperazine and morpholine as per CAS No. 1078142-02-5 (e.g. MCA PPM Triazine HF from MCA Technologies GmbH, Biel-Benken, Switzerland). Suitable synergists are preferably antimony compounds, especially antimony trioxide and antimony pentoxide, zinc compounds, tin compounds, especially zinc stannate, and borates, especially zinc borate.

It is also possible to add what are called carbon formers, especially polyphenylene ether, and anti-dripping agents, such as tetrafluoroethylene polymers, to the flame retardant.

Of the halogenated flame retardants, particular preference is given to using ethylene-1,2-bistetrabromophthalimide, tetrabromobisphenol A oligocarbonate, polypentabromobenzyl acrylate or brominated polystyrene, especially Firemaster® PBS64 (Great Lakes, West Lafayette, USA), in each case in combination with antimony trioxide and/or aluminium tris(diethylphosphinate).

Among the halogen-free flame retardants, particular preference is given to using aluminium tris(diethylphosphinate) (CAS No. 225789-38-8), in combination with melamine polyphosphate (e.g. Melapur® 200/70 from BASF SE, Ludwigshafen, Germany) (CAS No. 41583-09-9) and/or melamine cyanurate (e.g. Melapur® MC25 from BASF SE, Ludwigshafen, Germany) (CAS No. 37640-57-6) and/or phenoxyphosphazene oligomers (e.g. Rabitle® FP110 from Fushimi Pharmaceutical Co., Ltd, Kagawa, Japan) (CAS No. 28218-48-8).

Very especially preferably, it is also possible to use aluminium tris(diethylphosphinate) (e.g. Exolit® OP1240 from Clariant International Ltd., Muttenz, Switzerland) (CAS No. 225789-38-8) as the sole flame retardant.

Irrespective of component d), additional fillers and/or reinforcers may be present as additives in the inventive compositions.

Preference is also given to a mixture of two or more different fillers and/or reinforcers, especially based on mica, silicate, quartz, wollastonite, kaolin, amorphous silicas, magnesium carbonate, chalk, feldspar, barium sulphate, glass beads and/or fibrous fillers and/or reinforcers based on carbon fibres. Preference is given to using mineral particulate fillers based on mica, silicate, quartz, wollastonite, kaolin, amorphous silicas, magnesium carbonate, chalk, feldspar or barium sulphate.

Particular preference is additionally also given to using acicular mineral fillers as an additive. Acicular mineral fillers are understood in accordance with the invention to mean a mineral filer with a highly pronounced acicular character. The mineral filler preferably has a length:diameter ratio of 2:1 to 35:1, more preferably of 3:1 to 19:1, most preferably of 4:1 to 12:1. The median particle size of the acicular minerals for use as additive h) is preferably less than 20 μm, more preferably less than 15 μm, especially preferably less than 10 μm, determined with a CILAS GRANULOMETER in analogy to ISO 13320:2009 by means of laser diffraction.

As already described above for component d), in a preferred embodiment, the filler and/or reinforcer for use as additive h) may have been surface-modified, more preferably with an adhesion promoter or adhesion promoter system, especially preferably based on silane. However, the pretreatment is not absolutely necessary.

For the surface modification of the fillers for use as additive h), the silane compounds are generally used in amounts of 0.05% to 2% by weight, preferably 0.25% to 1.5% by weight and especially 0.5% to 1% by weight, based on the mineral filler for surface coating.

The particulate fillers for use as additive h) too may, as a result of the processing to give the moulding composition or shaped body, have a lower d97 or d50 value with respect to the median particle size in the moulding composition or in the shaped body than the fillers originally used, employing the abovementioned determination methods.

In a preferred embodiment, the present invention relates to compositions comprising PCT, PET, titanium dioxide, glass fibres and talc.

In a preferred embodiment, the present invention relates to compositions comprising PCT, PET, titanium dioxide, glass fibres, talc and tetrakis(2,4-di-tert-butylphenyl)-1,1-biphenyl-4,4′-diyl bisphosphonite.

In a preferred embodiment, the present invention relates to compositions comprising PCT, PET, titanium dioxide, glass fibres, talc, tetrakis(2,4-di-tert-butylphenyl)-1,1-biphenyl-4,4′-diyl bisphosphonite (CAS No. 38613-77-3) and at least one demoulding agent selected from the group of ester waxes, pentaerythrityl tetrastearate (PETS), long-chain fatty acids, especially stearic acid (CAS No. 57-11-4) or behenic acid (CAS No. 112-85-6), and salts thereof, especially Ca stearate or Zn stearate, and also amide derivatives, especially ethylenebisstearylamide (CAS No. 130-10-5), and montan waxes, especially mixtures of straight-chain, saturated carboxylic acids having chain lengths of 28 to 32 carbon atoms, and also low molecular weight polyethylene waxes or polypropylene waxes or ethylene homopolymer waxes.

In a preferred embodiment, the present invention relates to compositions comprising PCT, PET, titanium dioxide, glass fibres, talc, tetrakis(2,4-d-tert-butylphenyl)-1,1-biphenyl-4,4′-diyl bisphosphonite and ethylene homopolymer wax.

The present invention also relates to the use of the inventive compositions in the form of moulding compositions, for production of products resistant to heat distortion for short periods, preferably electric and electronic assemblies and components, especially preferably optoelectronic products.

Moulding compositions for use in accordance with the invention for injection moulding or for extrusion are obtained by mixing the individual components of the inventive compositions in at least one mixing apparatus, preferably by means of at least one mixing or kneading apparatus, discharging them to form an extrudate, cooling the extrudate until it is pelletizable and pelletizing it.

Preference is given to mixing the individual components at temperatures in the range from 285 to 310° C. in the melt. Especially preferably, a twin-shaft extruder is used as the mixing apparatus for this purpose.

In a preferred embodiment, the thermoplastic moulding composition comprising the inventive composition, which is then in the form of pellets, is dried in the region of 120° C. in a vacuum drying cabinet for a period of about 2 h, before the pellets are subjected as matrix material to the injection moulding operation or an extrusion process for the purpose of producing products.

The present invention also relates to a process for producing products, preferably products resistant to heat distortion for short periods, preferably for the electrics or electronics industries, more preferably electronic or electric assemblies and components, by mixing inventive compositions, discharging them to form a moulding composition in the form of an extrudate, cooling the extrudate until it is pelletizable and pelletizing it, and subjecting the pelletized material in the form of a matrix material comprising the inventive compositions to an injection moulding or extrusion operation, preferably an injection moulding operation.

The present invention also relates to a process for improving the short-term heat distortion resistance of polyester-based products, characterized in that inventive compositions in the form of moulding compositions are processed by means of injection moulding or extrusion in the form of a matrix material.

The processes of injection moulding and extrusion of thermoplastic moulding compositions are known to those skilled in the art.

Inventive processes for producing products by extrusion or injection moulding work at melt temperatures in the range from 230 to 330° C., preferably in the range from 250 to 300° C., and optionally additionally at pressures of not more than 2500 bar, preferably at pressures of not more than 2000 bar, more preferably at pressures of not more than 1500 bar and most preferably at pressures of not more than 750 bar.

Sequential coextrusion involves expelling two different materials successively in alternating sequence. In this way, a preform having different material composition section by section in extrusion direction is formed. It is possible to provide particular article sections with specifically required properties through appropriate material selection, for example for articles with soft ends and a hard middle section or integrated soft bellows regions (Thielen, Hartwig, Gust, “Blasformen von Kunststoffhohlkörpern” [Blow-Moulding of Hollow Plastics Bodies], Cad Hanser Verlag, Munich 2006, pages 127-129).

The process of injection moulding features melting (plasticization) of the raw material, preferably in pellet form, in a heated cylindrical cavity, and injection thereof as an injection moulding material under pressure into a temperature-controlled cavity. After the cooling (solidification) of the material, the injection moulding is demoulded.

The following stages are distinguished:

1. plasticization/melting
2. Injection phase (filling operation)
3. Hold pressure phase (owing to thermal contraction in the course of crystallization)

### 4. Demoulding.

An injection moulding machine consists of a closure unit, the injection unit, the drive and the control system. The closure unit includes fixed and movable platens for the mould, an end platen, and tie bars and the drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mould, the incoming melt is then separated and cooled, and hence the product to be produced is produced. Two halves of the mould are always needed for this purpose. In injection moulding, the following functional systems are distinguished:
runner system
shaping inserts
venting
machine casing and force absorber
demoulding system and movement transmission
temperature control

In contrast to injection moulding, extrusion uses a continuous shaped polymer extrudate, a polyamide here, in the extruder, the extruder being a machine for producing shaped thermoplastics. The following apparatuses are distinguished:
single-screw extruder and twin-screw extruder and the respective sub-groups,
conventional single-screw extruder, conveying single-screw extruder,
contra-rotating twin-screw extruder and co-rotating twin-screw extruder.

Extrusion systems consist of extruder, mould, downstream equipment, extrusion blow moulds. Extrusion systems for production of profiles consist of: extruder, profile mould, calibration, cooling zone, caterpillar take-off and roll take-off, separating device and tilting chute.

The present invention consequently also relates to products, especially to products resistant to heat distortion for short periods, obtainable by extrusion, profile extrusion or injection moulding of the Inventive compositions.

The present invention also relates to a process for producing products resistant to heat distortion for short periods, characterized in that compositions comprising PCT and PET, and also titanium dioxide, are processed in an injection moulding operation or by means of extrusion.

The present invention preferably relates to a process for producing products resistant to heat distortion for short periods, characterized in that the thermoplastic moulding compositions comprising the inventive compositions, preferably
a) 3% to 30% by weight, preferably 5% to 25% by weight, more preferably 10% to 20% by weight, of poly(1,4-cyclohexylenedimethylene) terephthalate (PCT), where the proportion of PCT based on the sum total of all the thermoplastic polymers present in the composition is in the range from 5% to 40% by weight, preferably 7% to 30% by weight, more preferably 10-25% by weight,
b) 15% to 90% by weight, preferably 20% to 70% by weight, more preferably 30% to 60% by weight, of polyethylene terephthalate (PET) and
c) 7% to 70% by weight, preferably 10% to 40% by weight, more preferably 15% to 35% by weight, of titanium dioxide, where the individual components should be combined with one another in such a way that the sum total of all the percentages by weight is 100, are processed as matrix material in an injection moulding or extrusion operation.

The products obtainable by the processes mentioned surprisingly exhibit excellent short-term heat distortion resistance, especially in soldering processes, and optimized properties in reflection after thermal stress, and in terms of mechanical properties, and additionally feature a lower processing temperature compared to the prior art.

The present invention also relates to the use of the inventive compositions for enhancing the short-term heat distortion resistance of polyester-based products, especially of optoelectronic polyester-based products.

The products produced in the inventive manner are therefore of excellent suitability for electric or electronic products, preferably optoelectronic products, especially LEDs or OLEDs.

A light-emitting diode (also called luminescence diode, LED) is an electronic semiconductor component. It current flows through the diode in forward direction, it emits light, infrared radiation (in the form of an infrared light-emitting diode) or else ultraviolet radiation with a wavelength dependent on the semiconductor material and the doping.

An organic light-emitting diode (OLED) is a thin-film light-emitting component composed of organic semiconductor materials, which differs from the inorganic light-emitting diodes (LEDs) in that the current density and luminance are lower, and monocrystalline materials are not required. Compared to conventional (inorganic) light-emitting diodes, organic light-emitting diodes are therefore less expensive to produce, but their lifetime is currently shorter than the conventional light-emitting diodes.

### EXAMPLES

To produce the compositions described in accordance with the invention, the individual components were mixed in a twin-shaft extruder (ZSK 26 Mega Compounder from Coperion Werner & Pfleiderer (Stuttgart, Germany)) at temperatures in the range from 285 to 310° C. in the melt and discharged as an extrudate, and the extrudate was cooled until pelletizable and pelletized. Before further steps, the pelletized material was dried at 120° C. in a vacuum drying cabinet for about 2 h.

The sheets and test specimens for the studies listed in Table 1 were injection-moulded on a conventional injection moulding machine at a melt temperature of 285-295° C. and a mould temperature of 80-120° C.

### Short-Term Heat Distortion Resistance

The test for determining short-term heat distortion resistance or solder bath resistance simulates the conditions of wave soldering as follows:

From a sheet having a thickness of 1.0 mm, test specimens of dimensions 20·10·1 mm were cut out. These were introduced into a conventional hot air oven heated at the temperature specified in Table 1 for 15 min. Subsequently, the partial melting characteristics of the specimens were assessed visually. “+” represents a sample with no visually observable partial melting, “o” a sample having rounded edges and “−” a sample that has partially melted over the entire surface.

### Reflection

As a value for the reflection, the gloss value was determined at 440 and 450 nm to DIN 5033-4 on a Minolta colorimeter (CM2600D) under D65 light on test specimens of dimensions 60 mm·40 mm·4 mm.

Loss of Reflection after Hot Air Ageing

For the hot air ageing, the test specimens of dimensions 60 mm·40 mm·4 mm were stored in a conventional hot air oven at 140° C. for 28 days. After storage, the test specimens were taken out of the oven and, after cooling to room temperature, the reflection was measured as described above and compared as a percentage to the corresponding reflection value prior to storage.

### Flexural Modulus and Flexural Strength

Flexural modulus [Pa] and flexural strength of the products produced from the inventive thermoplastic moulding compositions were determined in a bending test to ISO 178-A at 23° C.

### Impact Resistance

The impact resistance of the products produced from the inventive thermoplastic moulding compositions was determined in an impact test to ISO 180-1U at 23° C. [kJ/m²].

### Reactants

PCT: poly(1,4-cyclohexanedimethanol terephthalate) having an intrinsic viscosity of 110 g/cm³
PET: polyethylene terephthalate (Polyester Chips PET V004, from Invista, Wichita, USA)
GF: glass fibres having a diameter of 10 μm, coated with a slip containing silane compounds (CS 7967, commercial product from Lanxess N.V., Antwerp, Belgium)
Titanium dioxide: Inorganic titanium dioxide commonly used in polyesters (e.g. Kronos® 2230 from Kronos, Dallas, USA)
Talc: Mistron® R10 from Imerys Talc Group, Toulouse, France (Rio Tinto Group)
Phosphite stabilizer: Hostanox® P-EPQ (CAS No. 119345-01-6) from Clariant International Ltd., Muttenz, Switzerland, with tetrakis(2,4-di-tert-butylphenyl)-1,1-biphenyl-4,4′-diyl bisphosphonite (CAS No. 38613-77-3).
Demoulding agent: Luwax® A from BASF SE, Ludwigshafen, Germany

It is apparent from Table 1 that the inventive compositions (Examples 1 to 3), compared to polymer compositions based on PCT as the sole polymer component (Comparative 1), have much better reflection values after hot air storage and better mechanical properties combined with equally good short-term heat distortion resistance up to 285° C. Compared to polymer compositions based on PET as the sole polymer component, the inventive compositions (Examples 1 to 3) exhibit much better reflection values after hot air storage and better short-term heat distortion resistances at 275 and 285° C. combined with equally good mechanical properties.

TABLE 1

| Formulations | Comp. 1 | Comp. 2 | Ex. 1 | Ex. 2 | Ex. 3 |
|---|---|---|---|---|---|
| PCT | 52.95 | 0 | 5 | 10 | 15 |
| PET | 0 | 52.95 | 47.95 | 42.95 | 37.95 |
| Talc | 1 | 1 | 1 | 1 | 1 |
| Titanium dioxide | 20 | 20 | 20 | 20 | 20 |
| GF | 25 | 25 | 25 | 25 | 25 |
| Phosphite stabilizer | 0.75 | 0.75 | 0.75 | 0.75 | 0.75 |
| Demoulding agent | 0.3 | 0.3 | 0.3 | 0.3 | 0.3 |
| Test results | | | | | |
| Soldering at 265° C. | + | + | + | + | + |
| Soldering at 275° C. | + | o | + | + | + |
| Soldering at 285° C. | + | − | + | + | + |
| Reflection remaining | 94 | 94 | 97 | 98 | 97 |
| in [%] after storage at | | | | | |
| 140° C. for 28 days | | | | | |
| IZOD impact resistance | 15 | 25 | 25 | 26 | 24 |
| Flexural modulus | 9750 | 10626 | 10643 | 10271 | 10445 |

Amounts of the components in Table 1 each given in % by weight.

What is claimed is:

1. Compositions comprising
a) 3% to 30% by weight of poly(1,4-cycohexylenedimethylene) terephthalate (PCT), where the proportion of PCT based on the sum total of all the themoplastic polymers present in the composition is in the range from 5% to 40% by weight,
b) 15% to 90% by weight of polyethylene terephthalate (PET) and
c) 7% to 70% by weight of titanium dioxide, where the individual components should be combined with one another
in such a way that the sum total of al the percentages by weight is 100.

2. Compositions according to claim 1, characterized in that the titanium dioxide for use as component c) has a median particle size (d50) in the range from 90 nm to 2000 nm.

3. Compositions according to claim 1, characterized in that they comprise, in addition to components a), b) and c), also d) 5% to 50% by weight of glass fibres, in which case the level of at least one of components a), b) and c) should be reduced to such an extent that the sum total of all the percentages by weight is 100.

4. Compositions according to claim 3, characterized in that component d) is cut long glass fibres having a starting length in the range from 1 to 50 mm.

5. Compositions according to claim 3, characterized in that component d) has a fibre diameter in the range from 7 to 18 μm.

6. Compositions according to claim 3, characterized in that they comprise, in addition to components a), b), c) and optionally d) or instead of d), also e) 0.01% to 15% by weight of talc, in which case the level of at least one of the other components should be reduced to such an extent that the sum total of all the percentages by weight is always 100.

7. Compositions according to claim 6, characterized in that microcrystalline talc having a median particle size d50 in the range from 0.5 to 10 μm is used.

8. Compositions according to claim 6, characterized in that they comprise, in addition to components a), b), c) and optionally d) and/or e) or instead of components d) and/or e), also f) 0.01% to 1% by weight of at least one phosphite stabilizer, in which case the level of at least one of the other components should be reduced to such an extent that the sum total of all the percentages by weight is 100.

9. Compositions according to claim 8, characterized in that the phosphite stabilizer used is at least one selected from the group of tris(2,4-di-tert-butylphenyl)phosphite, bis(2,4-di-tert-butylphenyl)pentaerythrityl diphosphite, bis(2,6-dl-tert-butyl-4-methylphenyl)pentaerythrityl diphosphite, bis(2,4-dicumylphenyl)pentaerythrityl diphosphite, tris(nonylphenyl)phosphite, (2,4,6-tri-t-butylphenol)-2-butyl-2-ethyl-1,3-propanediol phosphite and tetrakis(2,4-di-tert-butylphenyl)-1,1-biphenyl-4,4′-diyl bisphosphonite.

10. Compositions according to claim 9, characterized in that the phosphite stabilizer used is at least tetrakis(2,4-di-tert-butylphenyl)-1,1-biphenyl-4,4′-diyl bisphosphoite.

11. Compositions according to claim 8, characterized in that they comprise, in addition to components a), b), c) and optionally d) and/or e) and/or f) or instead of components d) and/or e) and/or f), also g) 0.01% to 15% by weight of at least one demoulding agent, in which case the level of at least one of the other components should be reduced to such an extent that the sum total of all the percentages by weight is 100.

12. Compositions according to claim 11, characterized in that the demoulding agent used is at least one from the group of ester wax(es), pentaerythrityl tetrastearate (PETS), long-chain fatty acids, salt(s) of the long-chain fatty acids, amide derivative(s) of the long-chain fatty acids, montan waxes and low molecular weight polyethylene or polypropylene wax(es), and ethylene homopolymer wax(es).

13. Compositions according to claim 12, characterized in that long-chain fatty acids used are stearic acid or behenic acid, salts of long-chain fatty acids used are calcium stearate or zinc stearate, the amide derivative of long-chain fatty acids used is ethylenebisstearylamide, and montan waxes used are mixtures of straight-chain, saturated carboxylic acids having chain lengths of 28 to 32 carbon atoms.

14. Products obtainable by extrusion or injection moulding of moulding compositions comprising the compositions according to claim 1.

15. Process for producing products resistant to heat distortion for short periods, characterized in that compositions according to claim 1 are processed as matrix material in the form of thermoplastic moulding compositions in an injection moulding or extrusion operation.
